(19) United States
(12) Patent Application Publication
(10) Pub. No.: US 2005/0279381 A1
(43) Pub. Date: Dec. 22, 2005

(54) Method for cleaning microstructure

(75) Inventors: Kaoru Masuda, Hyogo (JP); Katsuyuki Iijima, Kobe-shi Hyogo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Hyogo (JP)

(21) Appl. No.: 10/532,408

(22) PCT Filed: Nov. 4, 2003
(86) PCT No.: PCT/JP03/14045

§ 371 Date: Apr. 22, 2005

(30) Foreign Application Priority Data
Nov. 5, 2002 (JP) 2002-320941

(51) Int. Cl. C23G 1/00; B08B 3/00

(52) U.S. Cl. 134/2

(57) ABSTRACT

The present invention provides a method for cleaning a microstructure capable of efficiently removing pollutants such as resist residue without causing damage to a substance such as a low-k film which is necessary for a semiconductor wafer. The cleaning method includes fluidizing a cleaning agent composition essentially containing carbon dioxide and a cleaning component under high pressure, and bringing the cleaning agent composition into contact with a microstructure to remove a substance adhering to the microstructure, wherein hydrogen fluoride is used as the cleaning component.

### TECHNICAL FIELD

The present invention relates to a method for cleaning a structure having a surface (microstructure surface) with micro irregularity, such as a semiconductor wafer, and for example, a cleaning method for removing resist residue and the like from a semiconductor wafer in a semiconductor manufacturing process.

### BACKGROUND ART

A semiconductor manufacturing process frequently uses a step for forming a pattern using a resist. However, the resist unnecessary after being used for masking in etching is removed by ashing with oxygen plasma or the like (ashing step). Therefore, a cleaning step must be performed after the ashing step, for removing pollutants such as residue after the etching step and resist residue, which cannot be separated and removed from the wafer surface even by the ashing step. The cleaning step is an important step performed not only after the ashing step and performed frequently in the semiconductor manufacturing process.

In recent years, research has been conducted for using liquefied or supercritical (referred to as “high pressure” hereinafter) carbon dioxide having low viscosity and excellent penetration force as a medium for a cleaning liquid and a rinsing liquid in the cleaning step. The high-pressure carbon dioxide has excellent penetration into a micropattern and a high cleaning effect and permits drying without causing a gas-liquid interface, thereby causing no possibility that the pattern is collapsed by capillary force, as compared with wet cleaning with an aqueous medium.

Although the high-pressure carbon dioxide functions as a low-viscosity solvent, it has insufficient solvent power for pollutants and thus has insufficient cleaning power by itself. Therefore, the inventors invented a cleaning method using high-pressure carbon dioxide to which a basic substance serving as a cleaning component and an alcohol serving as a compatibilizer for dissolving the basic substrate are added, and filed an application on the invention (Japanese Unexamined Patent Application Publication No. 2002-237481).

However, as a result of further research carried out by the inventors, when a semiconductor wafer on which a low-dielectric-constant interlayer insulating film (Low-k film), which has been recently put in heavy use, was formed was cleaned with a supercritical fluid containing a basic substance, the problem of deteriorating wafer quality occurred. This problem frequently occurs in use of a cleaning component having the high ability to remove resist residue. This is possibly due to the fact that the Low-k film having a composition similar to the resist residue is damaged by etching to deform a micropattern.

Accordingly, an object of the present invention is to provide a method for cleaning a microstructure capable of effectively removing pollutants such as resist residue without damaging a substance, particularly a Low-k film or the like, which is necessary for a semiconductor wafer.

### DISCLOSURE OF INVENTION

A method of the present invention comprises fluidizing a cleaning agent composition essentially containing carbon dioxide and a cleaning component under high pressure, and bringing the cleaning agent composition into a contact with a microstructure, for removing a substance adhering to the microstructure. The gist of the method lies in that hydrogen fluoride is used as the cleaning component. By using high-pressure fluid carbon dioxide having penetration force and hydrogen fluoride having high cleaning power, pollutants such as resist residue and the like can be effectively removed without causing a trouble such as collapse of a pattern or the like.

In a preferred embodiment of the present invention, the hydrogen fluoride concentration in the cleaning agent composition is 0.0001 to 0.5% by mass because damage to a Low-k film can be decreased, and the cleaning efficiency can be improved. Also, the above-described concentration is preferred from the viewpoint of long life of an apparatus because corrosion of the apparatus can be suppressed.

Alternatively, gaseous hydrogen fluoride, which is gaseous at room temperature, may be supplied to a high-pressure vessel and mixed with the high-pressure carbon dioxide. However, in a method of preparing the cleaning agent composition by mixing hydrofluoric acid and high-pressure carbon dioxide, the concentration of hydrofluoric acid in the cleaning agent composition can be easily controlled to a low level.

In use of hydrofluoric acid, the water content in the cleaning agent composition is preferably controlled to 0.0001 to 0.5% by mass because damage to the Low-k film or the like can be further decreased.

The cleaning agent composition preferably further contains 1% by mass or more of an alcohol. Particularly, in cleaning a microstructure on which a Low-k film susceptible to damage is formed, the alcohol protects the Low-film and decreases damage thereto.

The present invention also provides a microstructure cleaned by the cleaning method of the present invention.

### BRIEF DESCRIPTION OF THE DRAWINGS

FIG. 1 is a drawing illustrating an example of a cleaning apparatus for carrying out a cleaning method of the present invention.

### BEST MODE FOR CARRYING OUT THE INVENTION

A cleaning method of the present invention is applied to a microstructure. A typical example of the microstructure is a semiconductor wafer on which pollutants such as resist residue and the like after ashing adhere near micro irregularity.

The resist residue possibly includes an inorganic polymer produced from a resist polymer by the ashing step, a modified product of the resist polymer produced by modification with fluorine used as an etching gas, a modified product of a polyimide or the like used for an anti-reflection film, or the like. The method of the present invention is suitable for removing such resist after ashing. Of course, the cleaning method of the present invention can be applied not only to removal of the resist residue but also to a case in which substances other than the resist residue to be removed are present on the wafer in the semiconductor manufacturing process. For example, the cleaning method of the present invention can be suitably applied to removal of a resist before ashing and after implantation and removal of residue present as micro projections on the flat wafer surface after CMP.

In particular, the method of the present invention is preferably applied to a semiconductor wafer on which a film susceptible to damage in the cleaning step, such as a Low-k film, is formed. Examples of the Low-k film to which the present invention is applied include films with a relative dielectric constant of about 3.0 or less, such as hybrid MSQ (methyl silsesquioxane) Low-k films (for example, “JSR LKD” series manufactured by JSR Inc.), Si-based Low-k films (for example, Black Diamond and the like manufactured by Applied Materials Inc.) produced by a CVD process, and organic Low-k films (for example, SiLK (trademark) manufactured by Dow Chemical Company, and FLARE (trademark) manufactured by Honeywell, Inc.). The Low-k film may be a film formed by either a spin-on process or a CVD process. Even when the Low-k film is a porous film (porous type), the method of the present invention can be desirably applied because impurities do not remain in pores. The method of the present invention can also be applied to a semiconductor wafer on which such a film susceptible to damage is not formed.

Furthermore, the microstructure to be cleaned by the method of the present invention is not limited to the semiconductor wafer, and the cleaning method of the present invention can be applied to any cleaning object comprising a base material such as a metal, plastic, ceramic, or the like, on the surface of which a micropattern is formed and a substance to be removed adheres or remains.

The cleaning method of the present invention uses hydrogen fluoride as the cleaning component in view of the insufficient cleaning power possessed by high-pressure carbon dioxide itself. The reason for using high-pressure fluid carbon dioxide is that the high-pressure carbon dioxide has a high diffusion coefficient, and thus the dissolved pollutants can be easily dispersed in a medium. Furthermore, when carbon dioxide becomes a supercritical fluid at higher pressure, it has a property intermediate between a gas and a liquid, and thus the high-pressure carbon dioxide more easily penetrates into micro recesses. The term “high pressure” means 5 MPa or more, and supercritical carbon dioxide may be produced at 31° C. and 7.1 MPa or more. However, carbon dioxide becomes a gaseous fluid and exhibits sufficient penetration as a cleaning medium at a pressure of 5 MPa or more and 20° C. or more. Therefore, cleaning may be performed under these conditions.

The method of the present invention uses the cleaning agent composition essentially containing high-pressure carbon dioxide and hydrogen fluoride (HF) as the cleaning component. Although HF is conventionally used as a cleaning agent for wet-cleaning and dry-cleaning semiconductor wafers, hydrofluoric acid at a high concentration of about 1% by mass is used for wet cleaning, and thus has difficulty in handling. In dry cleaning, the Low-k film is etched with HF gas to produce particles of etching residue, and thus a rinsing step using water is required. It is known that the Low-k film itself is damaged by water used in the rinsing step, and water remains in the fine pores of a porous Low-k film to cause the adverse effect of increasing the dielectric constant. However, the method of the present invention uses a combination of HF and high-pressure carbon dioxide to decrease the HF concentration in the cleaning agent composition, thereby suppressing damage to the Low-k film. On the other hand, the cleaning power is increased by the excellent penetration force possessed by the high-pressure carbon dioxide, thereby permitting efficient cleaning.

The HF concentration is preferably 0.0001 to 0.5% by mass relative to 100% by mass of the cleaning agent composition. In order to exhibit high cleaning power and minimize damage to a film susceptible to damage, such as the Low-k film, the HF concentration must be controlled to the above range. If the HF concentration exceeds 0.5% by mass, the Low-k film is inevitably damaged. The upper limit of the HF concentration is more preferably 0.2% by mass. The term “damage to the Low-k film” means that the Low-k film itself is decreased in weight by etching in the cleaning step, or the residue newly produced by etching remains on the wafer after the cleaning step.

The damage decreases as the HF amount decreases, but a concentration of less than 0.0001% by mass is disadvantageous in that a long time is required for cleaning. Therefore, the lower limit is preferably 0.0001% by mass, more preferably 0.0002% by mass, and most preferably 0.001% by mass.

The cleaning agent composition of the present invention can be prepared by adding the HF in a gaseous form to the high-pressure carbon dioxide.

Alternatively, hydrofluoric acid, which is an aqueous solution of HF, may be mixed with the high-pressure carbon dioxide to prepare the cleaning agent composition. Use of hydrofluoric acid has advantage that the HF concentration in the cleaning agent composition may be significantly decreased by controlling the amount of hydrofluoric acid supplied to carbon dioxide, and the supply can be easily controlled in comparison to a case in which HF is supplied in a gaseous form. Furthermore, a mixture of hydrofluoric acid and an alcohol, which will be described below, may be supplied to carbon dioxide. In this case, control of the HF supply can be further facilitated. Namely, industrially available hydrofluoric acid is an aqueous solution of about 50% by mass of HF, and thus the HF concentration may be decreased to about 1 to 5% by mass by mixing the alcohol, and then HF is may be further diluted by mixing with the high-pressure carbon dioxide. Therefore, the HF concentration can be easily controlled to the above-described desirable value. When the cleaning agent composition is prepared using hydrofluoric acid, the water content in the cleaning agent composition is preferably 0.0001 to 0.5% by mass based on 100% by mass of the cleaning agent composition.

In cleaning the semiconductor wafer on which the Low-k film susceptible to damage is formed, the alcohol preferably coexists in the cleaning agent composition. This is because the alcohol has the function to moderate the cleaning action of HF and decrease the damage to the Low-k film. Also, the alcohol exhibits the function as a compatibilizer for solubilizing the water contained in hydrofluoric acid and pollutants slightly soluble in carbon dioxide in carbon dioxide. In order to exhibit the Low-k film protecting function and the compatibilizer function, the content of the alcohol in the cleaning agent composition is preferably 1% by mass or more, and the lower limit is preferably 2% by mass. Although the upper limit is not particularly limited, an increase in the alcohol content causes a decrease in the content of the high-pressure carbon dioxide used as the cleaning medium, thereby failing to exhibit the excellent penetration derived from the high-pressure carbon dioxide. Therefore, the upper limit is preferably 20% by mass or less, and more preferably 10% by mass or less. The alcohol can also be used in a first rinsing step after the cleaning step.

Specific examples of the alcohol include methanol, ethanol, n-propanol, isopropanol, n-butanol, isobutanol, diethylene glycol monomethyl ether, diethylene glycol monoethyl ether, and hexafluoroisopropanol.

As described above, the cleaning agent composition used in the method of the present invention essentially contains carbon dioxide and HF. In a preferred embodiment, the cleaning agent composition contains carbon dioxide, hydrofluoric acid, and an alcohol. However, the cleaning agent composition may further contain any other compound which does not cause a failure in achieving the object of the present invention.

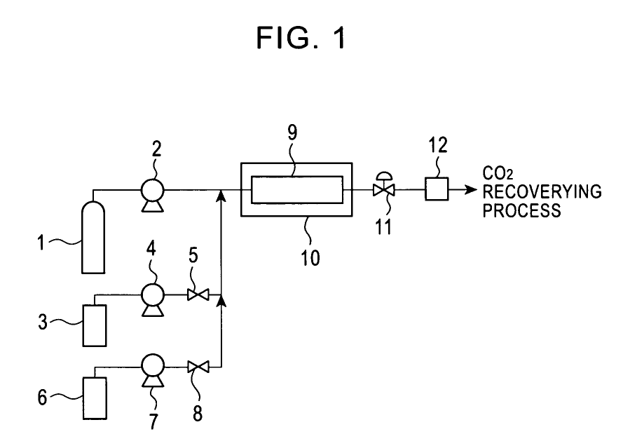

Next, the specific method for cleaning the microstructure using the cleaning agent composition will be described with reference to the drawing. FIG. 1 shows an example of a cleaning apparatus for carrying out the cleaning method of the present invention. In FIG. 1, reference numeral 1 denotes a cylinder of liquefied carbon dioxide; reference numeral 2, a carbon dioxide feed pump; reference numeral 3, a cleaning component tank (containing a mixed solution containing hydrofluoric acid and an alcohol, referred to as a “cleaning component” for convenience sake hereinafter); reference numeral 4, a cleaning component feed pump; reference numeral 5, a switching valve; reference numeral 6, a rinsing component tank; reference numeral 7, a rinsing component feed pump; reference numeral 8, a switching valve; reference numeral 9, a high-pressure vessel; and reference numeral 10, a thermostatic bath. The apparatus shown in FIG. 1 uses a method for supplying the mixed solution containing hydrofluoric acid serving as the cleaning component and the alcohol, the mixed solution containing hydrofluoric acid and the alcohol is stored in the cleaning component tank 3, and the alcohol is stored in the rinsing component tank 6. Alternatively, only hydrofluoric acid may be stored in the cleaning component tank 3, and the alcohol may be separately supplied from the rinsing component tank 6 as occasion demands. Furthermore, gaseous HF may be supplied to the high-pressure vessel 9 instead of the hydrofluoric acid.

In carrying out the cleaning step by the apparatus shown in FIG. 1, first, a cleaning object is placed in the high-pressure vessel 9. Then, carbon dioxide is supplied to the high-pressure vessel 9 from the carbon dioxide cylinder 1 through the pump 2 to control the pressure, and at the same time, the high-pressure vessel 9 is set to a predetermined temperature in the thermostatic bath 10. Instead of the thermostatic bath 10, a vessel with a heater may be used as the high-pressure vessel 9. Next, the cleaning components are introduced into the high-pressure vessel 9 from the tanks 3 and 6 through the pumps 4 and 7, respectively, to start the cleaning step. In this step, carbon dioxide and the cleaning components may be continuously supplied or may be supplied in a batch system in which the supply is stopped when the pressure reaches a predetermined value (or the supply is stopped, and the components are circulated).

The cleaning step is performed at 20° C. to 120° C. The cleaning step at 20° C. or lower requires a long time until the cleaning is finished, thereby decreasing the efficiency. When the supercritical carbon dioxide is used, the cleaning step is performed at 31° C. or higher. Even at a temperature of 120° C. or higher, the cleaning efficiency is not improved, and energy is wasted. The upper limit of the temperature is preferably 100° C. and more preferably 80° C. The pressure is preferably 5 to 30 MPa and more preferably 7.1 to 20 MPa. The time required for cleaning may be appropriately changed according to the size of the cleaning object and the amount of the pollutants adhering to the cleaning object. However, an increase in the cleaning time increases the damage to the Low-k film and deteriorates the efficiency. Therefore, the cleaning time is preferably 3 minutes or less and more preferably 2 minute or less for a general single wafer.

A rinsing step is performed after the cleaning step. In the rinsing step, when the solution containing resist residue or the like after cleaning is mixed directly with only carbon dioxide, the pollutants may precipitate from the solution, or the particles produced in the cleaning step may remain on the surface of the microstructure. Therefore, first, a mixture of carbon dioxide and the alcohol is mixed with the solution after cleaning in a first rinsing step. Although the solution composition may be changed by back mixing in the high-pressure vessel 9 when the cleaning step is switched to the first rinsing step, the use of the mixture of the alcohol and carbon dioxide as a first rinsing liquid can decrease a change in the solution composition and can decrease a change in solubility, thereby avoiding a trouble such as precipitation of the cleaning components or the like. From this viewpoint, the alcohol used in the rinsing step is preferably the same as that mixed with the cleaning component.

In the first rinsing step, the supply of the cleaning component is stopped by the switching valve 5. Then, the carbon dioxide and alcohol are introduced into the high-pressure vessel 9, and, at the same time, the solution after cleaning is discharged from the high-pressure vessel 9 according to the amounts of the carbon dioxide and alcohol introduced (a flowmeter 12 may be checked). In this step, preferably, the supply of the alcohol is gradually or stepwisely decreased using the switching valve 8 so that the high-pressure vessel 9 is finally filled with only carbon dioxide (second rinsing step). This is because when only carbon dioxide remains, the cleaning object can easily be dried. The liquids discharged in the cleaning step and the rinsing step can be separated into gaseous carbon dioxide and a liquid component in a carbon dioxide recovering process using, for example, a liquid-gas separator or the like, and thus each of the components can be recovered and reused.

After the rinsing step is completed, the pressure in the high-pressure vessel 9 is returned to normal pressure by a pressure control valve 11. In this step, carbon dioxide is substantially instantaneously evaporated as a gas, and thus the cleaning object such as a substrate or the like is dried without causing stains on the surface thereof or breakage of a micropattern.

The apparatus shown in FIG. 1 is an example of the simplest configuration, and the configuration may be changed by a known method.

### EXAMPLES

Although the present invention will be described in further detail below with reference to examples, the present invention is not limited to these examples, and modifications in the scope of the gist of the present invention are included in the technical field of the invention.

### Experimental Example 1

An organic silicone MSQ raw material was applied to a Si wafer by a spin-on process and then dried to form a MSQ porous Low-k film. Then, a photoresist pattern for ArF is formed on the film, and exposure and development were performed to form a wafer sample having a resist pattern in which lines and spaces (width 130 nm) alternately appeared, and a wide pattern of about 10-μm square. The Low-k film was patterned by etching with fluorine-based gas and then subjected to ashing with hydrogen plasma to remove the resist. As a result of observation of the wafer surface after ashing, resist residue was observed on the lines and the wide pattern on which the resist had been applied.

The sample after ashing was placed in the high-pressure vessel 9 in the apparatus shown in FIG. 1, and then the cover of the high-pressure vessel 9 was closed. Then, carbon dioxide was supplied to the high-pressure vessel 9 from the liquefied carbon dioxide cylinder 1 through the pump 2. The pressure in the vessel 9 was controlled to each of the predetermined values shown in Table 1, and at the same time, the high-pressure vessel 9 was maintained at each of the predetermined temperatures shown in Table 1 in the thermostatic bath 10. Then, the cleaning component was introduced into the high-pressure vessel 9 from the tank 3 through the pump 4, and the pressure in the high-pressure vessel 9 was controlled to each predetermined value shown in Table 1 using the pressure control valve. The cleaning step was performed using each of the compositions for each of the times shown in Table 1. Then, the first rising step using the alcohol (5% by mass) and carbon dioxide as the cleaning component and the second rinsing step using only carbon dioxide were performed, and then the pump 2 was stopped. Then, the pressure control valve 11 was opened to return the pressure in the high-pressure vessel 9 to normal pressure, and the wafer was removed therefrom.

In Table 1, EtOH represents ethanol, IPA represents isopropanol, and MeOH represents methanol. The alcohol amount corresponds to the balance, excluding CO₂, HF, and H₂O in 100% by weight of the cleaning liquid. In Run No. 17, the alcohol was not used.

The degree of removal of the resist residue after cleaning, damage to the Low-k film (change in the width of the line pattern due to etching), and the occurrence of a new residue after etching of the Low-k film were observed through a scanning electron microscope with a magnification of ×50,000, and evaluated on the basis of the criteria below. The results are shown in Table 1.

[Detergency (Removal of Resist Residue)]
A: No residue was observed.
B: Residue was observed on a portion of the lines or the wide pattern.
C: Residue was not removed.

[Damage to Low-K Film]
A: The line width was decreased by less than 5% by treatment.
B: The line width was decreased by 5% or more by treatment, but the pattern was not collapsed.
C: The line pattern was collapsed by excessive etching.

[Residue of Low-K Film]
A: No residue newly occurred.

B: The Low-k film was etched to produce residue.

TABLE 1

| | Operating condition | | Cleaning agent | | | | | Cleaning | Evaluation result | | |
|---|---|---|---|---|---|---|---|---|---|---|---|
| | Temperature | Pressure | composition (% by mass) | | | | | time | | Low-kfilm | |
| Run | (° C.) | (MPa) | CO₂ | HF | H₂O | Alcohol | | (minute) | Detergency | Damage | Residue |
| 1 | 40 | 15 | 95 | 0.05 | 0.05 | EtOH | 4.9 | 1 | A | A | A |
| 2 | 50 | 15 | 95 | 0.05 | 0.05 | EtOH | 4.9 | 1 | A | A | A |
| 3 | 60 | 15 | 95 | 0.05 | 0.05 | EtOH | 4.9 | 1 | A | A | A |
| 4 | 80 | 15 | 95 | 0.05 | 0.05 | EtOH | 4.9 | 1 | A | B | A |
| 5 | 40 | 10 | 95 | 0.05 | 0.05 | EtOH | 4.9 | 1 | A | A | A |
| 6 | 50 | 10 | 95 | 0.05 | 0.05 | EtOH | 4.9 | 1 | A | A | A |
| 7 | 50 | 15 | 95 | 0.05 | 0.05 | IPA | 4.9 | 1 | A | A | A |
| 8 | 50 | 15 | 95 | 0.05 | 0.05 | MeOH | 4.9 | 1 | A | A | A |
| 9 | 50 | 15 | 95 | 0.001 | 0.001 | EtOH | 4.998 | 1 | B | A | A |
| 10 | 50 | 15 | 95 | 0.02 | 0.02 | EtOH | 4.96 | 1 | A | A | A |
| 11 | 50 | 15 | 95 | 0.05 | 0.05 | EtOH | 4.9 | 1 | A | A | A |
| 12 | 50 | 15 | 95 | 0.05 | 0.05 | EtOH | 4.9 | 2 | A | A | A |
| 13 | 50 | 15 | 95 | 0.05 | 0.05 | EtOH | 4.9 | 3 | A | B | A |
| 14 | 50 | 15 | 90 | 0.05 | 0.05 | EtOH | 9.9 | 1 | A | A | A |
| 15 | 50 | 15 | 98 | 0.05 | 0.05 | EtOH | 1.9 | 1 | A | A | A |
| 16 | 50 | 15 | 98 | 0.02 | 0.02 | EtOH | 1.96 | 1 | A | A | A |
| 17 | 50 | 15 | 99.9 | 0.05 | 0.05 | — | — | 1 | A | B | A |
| 18 | 50 | 15 | 95 | 0.05 | 0.5 | EtOH | 4.45 | 1 | A | B | A |

### Experimental Example 2

### Comparative

Cleaning experiment (Run Nos. 19 and 20) was carried out by the same method as in Experimental Example 1 except that tetramethylammonium fluoride (TMAF) was used as a cleaning component in place of hydrofluoric acid. The results are shown in Table 2.

TABLE 2

| | Operating condition | | Cleaning agent | | | | Cleaning | Evaluation result | | |
|---|---|---|---|---|---|---|---|---|---|---|
| | Temperature | Pressure | composition (% by mass) | | | | time | | Low-kfilm | |
| Run | (° C.) | (MPa) | CO₂ | TMAF | Alcohol | | (minute) | Detergency | Damage | Residue |
| 19 | 50 | 15 | 95 | 0.013 | EtOH | 4.987 | 1 | A | A | B |
| 20 | 50 | 15 | 95 | 0.013 | EtOH | 4.987 | 3 | A | C | B |

### Example 3

### Dielectric Constant

An organic silicone MSQ material was applied to a Si wafer by a spin-on process and then heated to form a MSQ porous Low-k film (dielectric constant=2.5). The wafer on which the porous Low-k film was deposited was cleaned with a cleaning agent composition containing 95% by mass of CO₂, 0.01% by mass of HF, 0.01% by mass of H₂O, and the balance composed of ethanol at an operating temperature of 50° C. and a pressure of 15 MPa for 1 minute. After cleaning, Al was vapor-deposited on the porous Low-k film and measured with respect to the dielectric constant. As a result, the dielectric constant k was 2.5.

Separately, a wafer on which a porous Low-k film was deposited was wet-cleaned with an aqueous ammonium fluoride solution (a commercially available aqueous solution of about 10% remover) for 1 minute, rinsed with ultrapure water, and then spin-dried by blowing nitrogen at room temperature. As a result of the measurement of the dielectric constant as described above, the dielectric constant k was 2.7.

### Example 4

### Etching Rate

In order to measure damage to a Low-k film, cleaning experiment was conducted in a TMAF system (Run No. 21: comparative) and an example of the invention (Run Nos. 22 and 23) using a wafer on which a porous MSQ spin-on film was deposited by the same process as in Example 3, as shown in Table 3. The thickness of the film before the cleaning experiment was about 5000 Å, and the thickness was measured with an optical thickness meter before and after cleaning to determine a decrease in the film thickness. The decrease was divided by the cleaning time to determine the etching rate. Table 3 shows relative values of etching rates (obtained by dividing the decrease in the film thickness by the cleaning time) to 100 in the TMAF system (Run No. 21). Furthermore, cleaning experiment was conducted for a wafer on which a MSQ CVD film (Black Diamond produced by Applied Materials Inc.) was deposited as a Low-k film, and a wafer on which an organic spin-on film (SiLK (trademark) produced by Dow Chemical Company) was deposited as a Low-k film (Run Nos. 24 and 25). The results are also shown in Table 3.

TABLE 3

| | Operating condition | | Cleaning agent | | | | Cleaning | | |
|---|---|---|---|---|---|---|---|---|---|
| | Temperature | Pressure | composition (% by mass) | | | | time | | Etching rate |
| Run | (° C.) | (MPa) | CO₂ | TMAF | Alcohol | | (minute) | Low-k film | (relative value) |
| 21 | 50 | 15 | 95 | 0.013 | EtOH | 4.987 | 3 | Porous MSQ | 100 |
| | | | | | | | | spin-on film | |

| | Operating condition | | Cleaning agent | | | | | Cleaning | | |
|---|---|---|---|---|---|---|---|---|---|---|
| | Temperature | Pressure | composition (% by mass) | | | | | time | | Etching rate |
| Run | (° C.) | (MPa) | CO₂ | HF | H₂O | Alcohol | | (minute) | Low-k film | (relative value) |
| 22 | 50 | 15 | 95 | 0.05 | 0.05 | EtOH | 4.95 | 10 | Porous MSQ | <5 |
| | | | | | | | | | spin-on film | |
| 23 | 50 | 15 | 95 | 0.025 | 0.025 | EtOH | 4.975 | 10 | Porous MSQ | <5 |
| | | | | | | | | | spin-on film | |
| 24 | 50 | 15 | 95 | 0.05 | 0.05 | EtOH | 4.95 | 10 | MSQ CVD film | <5 |
| 25 | 50 | 15 | 95 | 0.05 | 0.05 | EtOH | 4.95 | 10 | Organic spin-on film | <5 |

### INDUSTRIAL APPLICABILITY

According to a cleaning method of the present invention, pollutants such as resist residue or the like can be efficiently removed by the penetration force of high-pressure fluid carbon dioxide and the high cleaning power of hydrogen fluoride without causing no trouble such as collapse of a pattern or the like.

1. A method for cleaning a microstructure comprising fluidizing a cleaning agent composition essentially containing carbon dioxide and a cleaning component under high pressure, and bringing the cleaning agent composition into contact with a microstructure to remove a substance adhering to the microstructure, wherein hydrogen fluoride is used as the cleaning component.

2. The method according to claim 1, wherein the hydrogen fluoride concentration in the cleaning agent composition is 0.0001 to 0.5% by mass.

3. The method according to claim 1, wherein the cleaning agent composition is prepared by mixing hydrofluoric acid and high-pressure carbon dioxide.

4. The method according to claim 3, wherein the water content in the cleaning agent composition is controlled to 0.0001 to 0.5% by mass.

5. The method according to claim 1, wherein the cleaning agent composition further contains 1% by mass or more an alcohol.

6. A microstructure cleaned by the method according to claim 1.
